(19) United States
(12) Patent Application Publication
(10) Pub. No.: US 2018/0371655 A1
(43) Pub. Date: Dec. 27, 2018

(54) FLAME RESISTANT POLYCARBONATE COMPOSITES FOR SEMI-STRUCTURAL PANELS

(71) Applicant: SABIC Global Technologies B.V., Bergen op Zoom (NL)

(72) Inventors: Richard PETERS, Hinsdale, MA (US); Markus ROHNER, Longs, SC (US); Lawrence DOHENY, Holly Springs, NC (US)

(21) Appl. No.: 16/062,188

(22) PCT Filed: Dec. 9, 2016
(86) PCT No.: PCT/US2016/065767

§ 371 Date: Jun. 14, 2018

Related U.S. Application Data
(60) Provisional application No. 62/270,247, filed on Dec. 21, 2015.

(51) Int. Cl. D04H 1/4242; D04H 1/4326; D04H 1/587; D04H 1/724; B29C 51/00

(52) U.S. Cl. CPC D04H 1/4242; D04H 1/4326; B29K 2105/0026; D04H 1/724; B29C 51/004; D04H 1/587

(57) ABSTRACT

Provided are polycarbonate fiber/carbon fiber composites and articles, the composites and articles having improved fire, smoke, and toxicity characteristics.

### TECHNICAL FIELD

The present disclosure relates to the field of fibrous composite materials useful in semi-structural applications.

### BACKGROUND

Current products used for semi-structural applications in some interior locations of aircraft are over-specified for the fire, smoke, and toxicity (FST) criteria for those applications. Typical materials used for these applications are aramids and similar products, but these products are expensive, difficult to work with, as they are thermoset type materials, and require a lot of manual labor to finish the panels for end use.

In some applications, however, the required FST performance is lower. As a consequence, there is a long-felt need in the art for other materials that can be used in these lower-performance applications. There is a particular need for materials that are available at a comparatively lower cost and materials that are processed by existing techniques.

### SUMMARY

In meeting the long-felt needs described above, the present disclosure provides composite formations using flame retardant polycarbonate fibers as the binder matrix with short cut carbon fiber and other fibers, combined in a wet laid process, and consolidated into sheet form to be used in semi-structural applications, including applications that require certain flame, smoke and toxicity performance. The disclosed technology uses a flame retardant polycarbonate (PC) melt spun staple fiber, which fiber may be selected to meet any necessary specifications when combined with other functional fibers including staple carbon fibers. Fibers may be combined in a wet laid process, consolidated, and then finished according to the end use application.

In one aspect, the present disclosure provides compositions for the manufacture of a non-woven, composite article, comprising: a plurality of flame retardant melt spun staple polycarbonate fibers; and a plurality of carbon fibers.

Also provided are methods for forming an article, comprising forming a layer comprising a suspension of the composition of claim 1 in liquid; at least partially removing the liquid from the suspension to form a web; heating the web under conditions sufficient to remove any remaining liquid from the web and to melt the polycarbonate fibers; and cooling the heated web to form an article that comprises the carbon fibers in a matrix of the polycarbonate.

Further disclosed are non-woven articles, comprising a network comprising a plurality of melted and cooled flame retardant melt spun staple polycarbonate fibers; and a plurality of carbon fibers disposed within the network.

Additionally provided are methods of forming a composite, comprising heating and compressing at least one of the articles of claims 15-17 disposed on a carrier layer under conditions sufficient to melt the polycarbonate fibers and consolidate the network; cooling the heated, compressed article and carrier layer under pressure to form the composite comprising a network comprising a plurality of polycarbonate fibers and a plurality of carbon fibers.

Also disclosed are thermoformable composites, comprising a network of melted, cooled polycarbonate fibers; and a plurality of carbon fibers disposed within the network of polycarbonate fibers.

### BRIEF DESCRIPTION OF THE DRAWING

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 provides an illustration of an exemplary, randomly-oriented carbon fiber mat.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the disclosed subject matter.

Also, as used in the specification including the appended claims, the singular forms “a,” “an,” and “the” include the plural, and reference to a particular numerical value includes at least that particular value, unless the context clearly dictates otherwise. Any documents mentioned herein are incorporated herein in their entireties for any and all purposes.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. When referring to a value, the term “about” means the value and all other values within 10% of the value. For example, “about 10” means from 9 to 11 and all intermediate values, including 10. Weight percentages should be understood as not exceeding a combined weight percent value of 100 wt. %. Where a standard is mentioned and no date is associated with that standard, it should be understood that the standard is the most recent standard in effect on the date of the present filing.

Aspect 1. A composition for the manufacture of a non-woven, composite article, comprising: a plurality of flame retardant melt spun staple polycarbonate fibers, and a plurality of carbon fibers. As described elsewhere herein, the present disclosure provides, inter alia, articles that comprise PC fibers and carbon fibers. The PC and carbon are formed into fibers by means known in the art. These fibers, together with other materials, may be combined to form a composition for the production of an article, such as a mat. Consolidation of the article under heat and pressure may be performed to yield a composite that can then be thermoformed to provide articles useful in the manufacture of interior aircraft panels, for example.

One exemplary polycarbonate composition is shown below by formula (I):

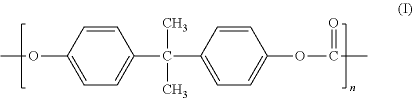

Polycarbonates are known to those of skill in the art. Polycarbonates, including aromatic carbonate chain units, include compositions having structural units of the formula (II):

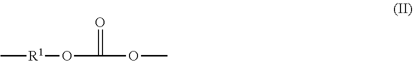

in which the R¹ groups are aromatic, aliphatic or alicyclic radicals. Preferably, R¹ is an aromatic organic radical, e.g., a radical of the formula (III):

-A¹-Y¹-A²- (III)

wherein each of A₁ and A₂ is a monocyclic divalent aryl radical and Y1 is a bridging radical having zero, one, or two atoms which separate A1 from A2. In an exemplary embodiment, one or more atoms separate A1 from A2. Illustrative examples of radicals of this type are —O—, —S(O)—, —S(O₂)—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, adamantylidene, or the like. In another embodiment, zero atoms separate A1 from A2, with an illustrative example being bisphenol. The bridging radical Y1 can be a hydrocarbon group or a saturated hydrocarbon group such as methylene, cyclohexylidene or isopropylidene.

Polycarbonates can be produced by, e.g., melt processes and also by interfacial reaction polymer processes, both of which are well known in the art. An interfacial process may use precursors such as dihydroxy compounds in which only one atom separates A¹ and A². As used herein, the term “dihydroxy compound” includes, for example, bisphenol compounds having general formula (IV) as follows:

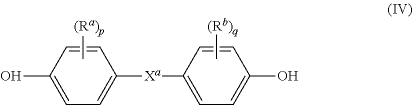

wherein R^{a} and R^{b} each independently represent hydrogen, a halogen atom, or a monovalent hydrocarbon group; p and q are each independently integers from 0 to 4; and X^{a} represents one of the groups of formula (V):

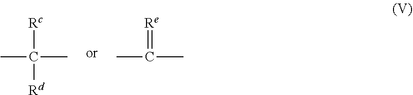

wherein R^{e} and R^{d} each independently represent a hydrogen atom or a monovalent linear or cyclic hydrocarbon group, and R^{e} is a divalent hydrocarbon group.

Examples of the types of bisphenol compounds that can be represented by formula (IV) include the bis(hydroxyaryl)alkane series. Other bisphenol compounds that can be represented by formula (IV) include those where X is —O—, —S—, —SO— or −SO22-. Other bisphenol compounds that can be utilized in the polycondensation of polycarbonate are represented by the formula (VI)

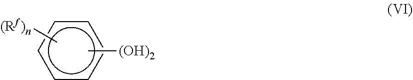

wherein, R^{f}, is a halogen atom of a hydrocarbon group having 1 to 10 carbon atoms or a halogen substituted hydrocarbon group; n is a value from 0 to 4. When n is at least 2, R^{f} can be the same or different. Examples of bisphenol compounds represented by formula (V), are resorcinol, substituted resorcinol compounds such as 3-methyl resorcin, and the like.

Bisphenol compounds (e.g., bisphenol A), such as 2,2,2′,2′-tetrahydro-3,3,3′,3′-tetramethyl-1,1′-spirobi-[IH-indene]-6,6′-diol represented by the following formula (VII) can also be used.

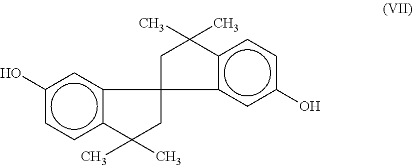

Branched polycarbonates, as well as blends of linear polycarbonate and a branched polycarbonate can also be used. Branched polycarbonates can be prepared by adding a branching agent during polymerization. These branching agents can include polyfunctional organic compounds containing at least three functional groups, which can be hydroxyl, carboxyl, carboxylic anhydride, haloformyl, and combinations including at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, benzophenone tetracarboxylic acid, or the like, or combinations including at least one of the foregoing branching agents. The branching agents can be added at a level of about 0.05 to about 2.0 weight percent (wt %), based upon the total weight of the polycarbonate in a given layer.

In one embodiment, the polycarbonate can be produced by a melt polycondensation reaction between a dihydroxy compound and a carbonic acid diester. Polycarbonate may also be end-capped.

Preferably, the weight average molecular weight of a polycarbonate is from about 3,000 to about 1,000,000 grams/mole (g/mole). Within this range, it may be desirable to have a weight average molecular weight of greater than or equal to about 10,000, preferably greater than or equal to about 20,000, and more preferably greater than or equal to about 25,000 g/mole. Also desirable is a weight average molecular weight of less than or equal to about 100,000, preferably less than or equal to about 75,000, more preferably less than or equal to about 50,000, and most preferably less than or equal to about 35,000 g/mole.

The PC and carbon fibers are suitably dispersed together, e.g., within a fluid medium. The dispersion may be random, as the fibers need not be oriented or entangled in any particular way; random orientation/entanglement is suitable. Fibers may also in some embodiments, be oriented in a particular way, but orientation is not a requirement.

The PC fibers may be round in shape, but this is not a requirement. Other cross-sectional geometries (e.g., ovoid, oblong, trilobular, or even polygonal) are also considered suitable. PC fibers may have a characteristic cross-sectional dimension (e.g., diameter, width) in the range of from about 0.1 micrometer to about 50 micrometers, or from about 0.5 micrometer to about 45 micrometers, or from about 1 micrometer to about 45 micrometers, or from about 2 micrometers to about 40 micrometers, or from about 5 micrometers to about 30 micrometers, or from about 10 micrometers to about 25 micrometers, or even about 15 micrometers. The plurality of the PC fibers may have any of the cross-sectional dimensions on average, e.g., on the basis of number average or on the basis of weight average. The plurality of PC fibers may be free of or essentially free of ribbon fibers.

The aspect ratio of a PC fiber may be less than about 500:1, or less than about 450:1, or less than about 450:1, or less than about 400:1, or less than about 350:1, or less than about 300:1, or less than about 250:1, or less than about 200:1, or less than about 150:1, or less than about 100:1, or less than about 50:1, or less than about 20:1, or less than about 10:1, or even less than about 5:1. The plurality of the PC fibers may have any of the aforementioned aspect ratios on an average basis, e.g., on the basis of number average or on the basis of weight average.

A carbon fiber may have a length of about 1 inch or less, e.g., about 0.95 inches or less, or about 0.90 inches or less, or about 0.85 inches or less, or about 0.80 inches or less, or about 0.75 inches or less, or about 0.70 inches or less, or about 0.65 inches or less, or about 0.60 inches or less, or about 0.55 inches or less, or about 0.50 inches or less, or about 0.45 inches or less, or about 0.40 inches or less, or about 0.35 inches or less, or about 0.30 inches or less, or about 0.25 inches or less, or about 0.20 inches or less, or about 0.15 inches or less, or about 0.10 inches or less, or even about 0.05 inches or less.

The plurality of the carbon fibers may have any of the aforementioned lengths on average, e.g., on the basis of number average or on the basis of weight average. For example, a plurality of carbon fibers may have a number average length of 0.80 inches.

The aspect ratio of a carbon fiber may be less than about 500:1, or less than about 450:1, or less than about 450:1, or less than about 400:1, or less than about 350:1, or less than about 300:1, or less than about 250:1, or less than about 200:1, or less than about 150:1, or less than about 100:1, or less than about 50:1, or less than about 20:1, or less than about 10:1, or even less than about 5:1. The plurality of the carbon fibers may have any of the aforementioned aspect ratios on average, e.g., on the basis of number average or on the basis of weight average.

Aspect 2. The composition of aspect 1, further comprising an amount of a binder material. The binder material may be selected to, e.g., promote the formation of a cohesive fiber mat during processing steps.

Aspect 3. The composition of aspect 2, wherein the binder material has a melting point lower than that of the plurality of polycarbonate fibers. Suitable such binders include polymers that have such melting points.

Aspect 4. The composition of any of aspects 2-3, wherein the binder material comprises a plurality of fibers. A binder may also be in the form of liquid, powder, flake, pellet, and the like. Fibrous binder materials are considered particularly suitable.

Aspect 5. The composition of any of aspects 2-4, wherein the binder material comprises polypropylene, polyethylene, ABS, PS, SAN, or any combination thereof. Other suitable binder materials include Triton-X™, Aquosol™, PLA, or other materials that have a lower melt temperature than the PC fibers.

Aspect 6. The composition of any of aspects 1-5, wherein the PC fiber is characterized as UL94 VO rated at 1.2 mm.

Composites and/or articles according to the present disclosure may also suitably satisfy any applicable standards from [14 CFR] section 25.853 and part 25, appendix F, part I. As one example, an article according to the present disclosure that is applied as an interior wall panel (cabin, first class, or even cargo) may satisfy the applicable standard under 14 CFR 25.853.

Aspect 7. The composition of any of aspects 1-6, wherein the polycarbonate fibers are present at from about 10 to about 90%, or from about 15 to about 85%, or from about 20 to about 80%, or from about 25 to about 75%, or from about 30 to about 70%, or from about 35 to about 65%, or from about 40 to about 60%, or from about 45 to about 55%, or even about 50% of the total weight of the composition.

Aspect 8. The composition of any of aspects 1-7, wherein the carbon fiber is present at from about 10 to about 90%, or from about 15 to about 85%, or from about 20 to about 80%, or from about 25 to about 75%, or from about 30 to about 70%, or from about 35 to about 65%, or from about 40 to about 60%, or from about 45 to about 55%, or even about 50% of the total weight of the composition.

Aspect 9. The composition of any of aspects 2-8, wherein the binder is present at from about 0.1 to about 10 wt %, or from about 0.5 to about 7 wt %, or from about 1 to about 6 wt %, or from about 2 to about 5 wt %, or from about 3 to about 4 wt % of the total weight of the composition.

Aspect 10. The composition of any of aspects 1-9, further comprising a thermal stabilizer, an antioxidant, a light stabilizer, a gamma-irradiation stabilizer, a colorant, an antistatic agent, a lubricant, a mold release agent, a flame retardant, or any combination thereof.

The flame retardant may be incorporated into the PC fiber; the flame retardant may comprise any flame retardant material or mixture of flame retardant materials suitable for use in the inventive composition. In various aspects, the flame retardant component comprises a phosphate containing material. In a further aspect, the flame retardant component comprises an.

Flame retardants such as organic compounds that include phosphorus (e.g., phosphate, such as oligomeric phosphate, polymeric phosphate, mixed phosphate/phosphonate and combinations thereof), bromine, and/or chlorine are suitable. Examples include phosphazene, aryl phosphate, bisphenol A disphosphate, resorcinol bis-diphenylphosphate, bisphenol A bis(diphenyl phosphate) (BABDP), or resorcinol diphosphate (RDP), or a combination thereof.

Non-brominated and non-chlorinated phosphorus-containing flame retardants can be preferred in certain applications for regulatory reasons, for example organic phosphates and organic compounds containing phosphorus-nitrogen bonds. As some examples, potassium perfluorobutane sulfonate, siloxanes, and the like are suitable.

Still other flame retardants include phosphorus-containing flame retardants. Certain flame retardants are discussed in United States published patent application 2014/0107266, which is incorporated herein in its entirety. In some embodiments, a combination of flame retardants are shown to give synergistic properties.

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate. Salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, and/or Na₃AlF₆ may also be used.

A fiber may comprise a flame retardant in an amount of about 0 wt % to about 20 wt %, e.g., about 20 wt % or less, about 19 wt % or less, about 18 wt % or less, about 17 wt % or less, about 16 wt % or less, about 15 wt % or less, about 14 wt % or less, about 13 wt % or less, about 12 wt % or less, about 11 wt % or less, about 10 wt % or less, about 9 wt % or less, about 8 wt % or less, about 7 wt % or less, about 6 wt % or less, about 5 wt % or less, about 4 wt % or less, about 3 wt % or less, about 2 wt % or less, or even about 1 wt % or less, e.g., 0.09 wt % or less, about 0.089 wt % or less, about 0.088 wt % or less, about 0.087 wt % or less, about 0.086 wt % or less, about 0.085 wt % or less, about 0.084 wt % or less, about 0.083 wt % or less, about 0.082 wt % or less, about 0.081 wt % or less, about 0.080 wt % or less, about 0.079 wt % or less, about 0.078 wt % or less, about 0.077 wt % or less, about 0.076 wt % or less, about 0.075 wt % or less, about 0.074 wt % or less, about 0.073 wt % or less, about 0.072 wt % or less, about 0.071 wt % or less, about 0.070 wt % or less, about 0.069 wt % or less, about 0.068 wt % or less, about 0.067 wt % or less, about 0.066 wt % or less, about 0.065 wt % or less, about 0.064 wt % or less, about 0.063 wt % or less, about 0.062 wt % or less, about 0.061 wt % or less, about 0.060 wt % or less, about 0.059 wt % or less, about 0.058 wt % or less, about 0.057 wt % or less, about 0.056 wt % or less, about 0.055 wt % or less, about 0.054 wt % or less, about 0.053 wt % or less, about 0.052 wt % or less, about 0.051 wt % or less, or about 0.050 wt % or less, based on the total weight of the composition.

Aspect 11. A method for forming an article, comprising: forming a layer comprising a suspension of the composition of aspect 1 in liquid; at least partially removing the liquid from the suspension to form a web; heating the web under conditions sufficient to remove any remaining liquid from the web and to melt the polycarbonate fibers; and cooling the heated web to form an article that comprises the carbon fibers in a matrix of the polycarbonate.

Fibers may be combined in a liquid medium to form a suspension, wherein the fibers are substantially uniformly suspended and distributed throughout the medium. In one embodiment, the combining is performed by introducing the fibers into an aqueous medium to provide a suspension, which can be a slurry, dispersion, foam, or emulsion. The combining is performed so as to render the fibers substantially evenly dispersed in the aqueous medium, and can use agitation to establish and maintain the dispersion of these components. The suspension can further comprise additives such as dispersants, buffers, anti-coagulants, surfactants, and the like, and combinations thereof, to adjust or improve the flow, dispersion, adhesion, or other properties of the suspension.

A suspension can be, e.g., a foamed suspension comprising the fibers, water, and a surfactant. The percentage by weight of solids (wt %) of the suspension may be from 1 to 99 wt %, e.g., from about 2 to about 50 wt %. Additives can be present in an amount effective for imparting desired properties of foaming, suspension, flow, and the like.

A suspension can be prepared in batch mode, and used directly or stored for later use, or alternatively be formed in a continuous manufacturing process wherein the components are each combined to form the suspension at a time just prior to the use of the suspension.

To form an article such as a mat, the suspension is applied as a slurry to a porous surface, for example a wire or other mesh, and the liquid and suspended components too small to remain on the porous surface are removed through the porous surface by gravity or use of vacuum, to leave a layer comprising a dispersion of fibers on the porous surface. The suspension may also be applied to a solid surface. Liquid may be removed via vacuum, sublimation, heating, or any combination of these. The liquid may be aqueous or non-aqueous. Water is considered a suitable such liquid.

In one exemplary embodiment, the porous surface is a conveyor belt having pores, and of dimensions suitable to provide, after application of the dispersed medium and removal of liquid, a fibrous mat having, e.g., a width of 2 meters and of continuous length. The dispersed medium can be contacted to the porous surface by distribution through a head box, which provides for application of a coating of the dispersed medium having a substantially uniform width and thickness over the porous surface. Typically, vacuum is applied to the porous surface on a side opposite the side to which the dispersed medium is applied so as to draw the residual liquid and/or small particles through the porous surface, thereby providing a web in substantially dried form. In an embodiment, the layer is dried to remove moisture by passing heated air through the layer mat.

Upon removal of the excess dispersed medium and/or moisture, the non-bonded, web comprising the fibers is thermally treated to form a porous article, for example a mat. In an embodiment, the web is heated by passing heated air through the web in a furnace. In this way, the web can be dried using air heated at a temperature of greater than or equal to, e.g., 100 deg. C. under a flow of air. Moisture may also be removed, however, with air or gas flow at less than 100 deg. C.

As described elsewhere herein, a heating temperature may be selected to substantially soften and melt a binder (e.g., a polymer binder), e.g., at a temperature from 130 to 170 deg. C. A temperature may be selected to soften and/or melt the PC fibers. During heating of the web, the binder melts and flows to form a common contact (e.g., a bridge) between two or more of the reinforcing and polyimide fibers, and forms an adhesive bond with the fibers upon cooling to a non-flowing state, thereby forming the porous article.

The composite or layered structure prepared therefrom can be rolled, folded, or formed into sheets. The composite can be cut or rolled to an intermediate form. The cut composite and/or the layered structure can be molded and expanded to form an article of a desired shape, for use in manufacture of further articles. The intermediate rolled, folded, or sheeted dual matrix composite or layered structure can further be molded into an article of a suitable shape, dimension, and structure for use in further manufacturing processes to produce further articles.

Layers may be thermally bonded to one another. Layers may also be adhered to one another using suitable adhesives; i.e., adhesives that satisfy any applicable criteria or regulations. The adhesives described in US2012/0321879 (incorporated herein by reference in its entirety) are considered suitable for some applications.

While any suitable method of forming an article using the composite is contemplated (e.g., thermoforming, profile extrusion, blow molding, injection molding, and the like), in a particular embodiment, the dual matrix composite is advantageously formed into an article by thermoforming, which can reduce the overall cost in manufacturing the article. It is generally noted that the term “thermoforming” is used to describe a method that can comprise the sequential or simultaneous heating and forming of a material onto a mold, wherein the material is originally in the form of a film, sheet, layer, or the like, and can then be formed into a desired shape. Once the desired shape has been obtained, the formed article (e.g., a component of an aircraft interior such as a panel) is cooled below its melt or glass transition temperature.

Exemplary thermoforming methods can include, but are not limited to, mechanical forming (e.g., matched tool forming), membrane assisted pressure/vacuum forming, membrane assisted pressure/vacuum forming with a plug assist, and the like. It can be noted the greater the draw ratio the greater the degree of lofting needs to be, to be able to form a useful part, both aesthetically and functionally.

In a particularly advantageous feature, the composites and articles formed from the dual matrix composites meet certain flame retardant properties presently required by the airline transportation industry.

Those skilled in the art will also appreciate that common curing and surface modification processes including but not limited to heat-setting, texturing, embossing, corona treatment, flame treatment, plasma treatment, and vacuum deposition can further be applied to the disclosed articles to alter surface appearances and impart additional functionalities to the articles. Additional fabrication operations can be performed on articles, such as, but not limited to molding, in-mold decoration, baking in a paint oven, lamination, and hard coating.

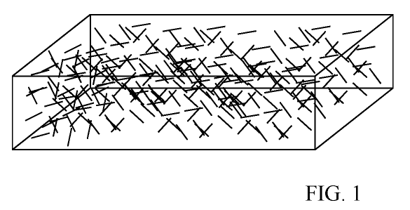

The PC fibers may in some embodiments be partially melted, i.e., such that they retain at least some of their fibrous pre-melt configuration. In other embodiments, the PC fibers may be completely melted such that the PC becomes a matrix material with carbon fibers randomly dispersed throughout. An exemplary carbon fiber article (in this case, a mat) is shown in FIG. 1, which FIGURE shows carbon fibers randomly dispersed throughout the mat.

Aspect 12. The method of aspect 11, wherein forming the web comprises depositing the composition dispersed in an aqueous suspension onto a forming support element to form the layer; and evacuating the aqueous solvent to form the web.

Aspect 13. The method of any of aspects 11-12, wherein the heating is at a temperature from about 100 to about 350 deg. C., e.g., from about 110 to about 340 deg. C., or from about 120 to about 330 deg. C., or from about 130 to about 320 deg. C., or from about 140 to about 320 deg. C., or from about 150 to about 310 deg. C., or from about 150 to about 300 deg. C., or from about 160 to about 290 deg. C., or from about 170 to about 280 deg. C., or from about 180 to about 270 deg. C., or from about 190 to about 260 deg. C., or from about 200 to about 250 deg. C., or from about 210 to about 240 deg. C., or from about 220 to about 230 deg. C. Heating may be effected via convection, radiant heating, or other methods.

Aspect 14. The method of any of aspects 11-13, wherein the heating comprises infrared heating at a temperature of from about 100 to about 350 deg. C.

Aspect 15. An article made according to any of aspects 11-14.

Aspect 16. A non-woven article, comprising: a network comprising a plurality of melted and cooled flame retardant melt spun staple polycarbonate fibers; and a plurality of carbon fibers disposed within the network.

Aspect 17. The non-woven article of claim 16, wherein the article has an areal weight of less than 1600 g/m², e.g., about 1550 g/m², about 1500 g/m², about 1450 g/m², about 1400 g/m², about 1350 g/m², about 1300 g/m², about 1250 g/m², about 1200 g/m², about 1150 g/m², about 1100 g/m², about 1050 g/m², about 1000 g/m², or less. An article can have an areal weight of, e.g., from about 90 to about 1400 g/m², including all intermediate values.

An article may be porous (or comprise pores within), although this is not a requirement. An article may have a porosity of greater than about 0%, more particularly about 5% to about 95%, and still more particularly about 20% to about 80% by volume.

The non-woven article may include an amount of one or more binders. Suitable binders are described elsewhere herein.

Aspect 18. A method of forming a composite, comprising: heating and compressing at least one of the articles of aspects 15-17 disposed on a carrier layer under conditions sufficient to melt the polycarbonate fibers and consolidate the network; cooling the heated, compressed article and carrier layer under pressure to form the composite comprising a network comprising a plurality of polycarbonate fibers and a plurality of carbon fibers.

Heat-treating and compression can be by a variety of methods, for example using calendaring rolls, double belt laminators, indexing presses, multiple daylight presses, autoclaves, and other such devices used for lamination and consolidation of sheets so that the polyimide can flow and wet out the fibers. The gap between the consolidating elements in the consolidation devices may be set to a dimension less than that of the unconsolidated web and greater than that of the web if it were to be fully consolidated, thus allowing the web to expand and remain substantially permeable after passing through the rollers.

In one embodiment, the gap between consolidating elements is set to a dimension about 5% to about 10% greater than that of the web if it were to be fully consolidated. It may also be set to provide a fully consolidated web that is later re-lofted and molded to form particular articles or materials. A fully consolidated web means a web that is fully compressed and substantially void free. A fully consolidated web would have less than about 5% void content and have negligible open cell structure.

Aspect 19. The method of aspect 18, comprising heating and compressing a stack comprising two or more of the composites.

Aspect 20. The method of aspect 18, comprising heating and compressing a stack comprising from two to ten of the composites.

Aspect 21. A thermoformable composite, comprising: a network of melted, cooled polycarbonate fibers; and a plurality of carbon fibers disposed within the network of polycarbonate fibers.

Aspect 22. The composite of aspect 21, wherein the composite has a minimum degree of loft of greater than or equal to about three.

Aspect 23. The composite of any of claims 21-22, wherein the loft of the composite is within one sigma over the entirety of the composite.

Alternatively, or in addition, the loft of the dual matrix composite is within 30%, over the entirety of the dual matrix composite. Loft can be understood as the expansion that the composite undergoes as it is reheated without pressure above the melt temperature of the PC, compared to the thickness of the fully consolidated material. It indicates the degree of glass fiber attrition that occurred during consolidation, which provides an indication of mechanical strength and formability.

Aspect 24. A method of forming an article, comprising thermoforming a composite according to of any of aspects 18-23 to form the article.

Aspect 26. An article, comprising a thermoformed composite of any of aspects 21-24.

Aspect 27. The article of any of aspects 15-17 or 26, further comprising a skin affixed thereto. The skin may be cosmetic, e.g., a decorative skin, a reflective skin, and the like.

Layers of thermoplastic material, woven and non-woven fabrics, and the like, can be laminated to the dual matrix composite to form a structure having two or more layers.

Lamination may be effected by feeding one or more optional top layers of material, and/or one or more bottom layers of material, such as for example a scrim layer, into a nip roller simultaneously with the dual matrix composite. The nip roller, which can be cooled by circulation of water through the rollers, can provide temperature control for the heated structure during application of pressure, and thus during formation of the composite. The roller pressure for compressing and/or compacting the fibrous mat and/or additional layers can be adjusted to maximize the final properties of the structure.

In this way, layers such as adhesion layers, barrier layers, scrim layers, reinforcement layers, and the like, or a combination comprising at least one of the foregoing layers, can be applied to the core material. The layers can be continuous sheets, films, woven fabric, nonwoven fabric, and the like, or a combination comprising at least one of the foregoing. Materials useful for the layers include polyolefins such as polyethylene, polypropylene, poly(ethylene-propylene), polybutylene, adhesion-modified polyethylenes, and the like; polyesters, including polyethylene terephthalate, polybutylene terephthalate, PCTG, PETG, PCCD, and the like; polyamides such as nylon 6 and nylon 6,6, and the like; polyurethanes, such as MDI based polyurethanes; and the like; or a combination comprising at least one of the foregoing.

Aspect 28. The article of any of aspects 15-17 or 26-27, wherein the article is in the form of an aircraft interior panel.

Articles prepared from these composites include those used to fabricate interior panels for aircraft, trains, automobiles, passenger ships, and the like, and are useful where good thermal and sound insulation are desired. Injection-molded parts such as aircraft parts including oxygen mask compartment covers; and thermoformed and non-thermoformed articles prepared from sheets of the dual matrix composites such thermoplastic such as light fixtures; lighting appliances; light covers, cladding or seating for public transportation; cladding or seating for trains, subways, or buses; meter housings; and like applications. Other specific applications include window shades (injection molded or thermoformed), air ducts, compartments and compartment doors for storage, luggage, seat parts, arm rests, tray tables, oxygen mask compartment parts, air ducts, window trim, and other parts such as panels used in the interior of aircraft, trains or ships.

Aspect 29. The article of any of claim 15-17 or 26-2, the article having an areal weight of less than about 1600 g/m², e.g., about 1550 g/m², about 1500 g/m², about 1450 g/m², about 1400 g/m², about 1350 g/m², about 1300 g/m², about 1250 g/m², about 1200 g/m², about 1150 g/m², about 1100 g/m², about 1050 g/m², about 1000 g/m², or less.

Aspect 30. The article of any of aspects 15-17 or 26-29, wherein the article has an aspect ratio of from about 1:10,000 to about 1:1, e.g., from about 1:90 to about 1:2 from about 1:80 to 1:3, from about 1:70 to about 1:4, from about 1:60 to about 1:5, from about 1:50 to about 1:6, from about 1:40 to about 1:7, from about 1:30 to about 1:8, from about 1:20 to about 1:9.

1. A composition for the manufacture of a non-woven, composite article, comprising:
a plurality of flame retardant melt spun staple polycarbonate fibers; and
a plurality of carbon fibers.

2. The composition of claim 1, further comprising an amount of a binder material that has a melting point lower than that of the plurality of polycarbonate fibers.

3. The composition of claim 2, wherein the binder material comprises a plurality of fibers.

4. The composition of claim 2, wherein the binder material comprises polypropylene, polyethylene, ABS, PS, SAN, or any combination thereof.

5. The composition of claim 1, wherein the polycarbonate fibers are present at from about 10 to about 90 wt %, measured against the total weight of the composition.

6. The composition of claim 1, wherein the carbon fiber is present at from about 10 to about 90 wt %, measured against the total weight of the composition.

7. A method for forming an article, comprising:
forming a layer comprising a suspension of the composition of claim 1 in liquid;
at least partially removing the liquid from the suspension to form a web;
heating the web under conditions sufficient to remove any remaining liquid from the web and to melt the polycarbonate fibers; and
cooling the heated web to form an article that comprises the carbon fibers in a matrix of the polycarbonate.

8. An article made according to the method of claim 7.

9. A non-woven article, comprising:
a network comprising a plurality of melted and cooled flame retardant melt spun staple polycarbonate fibers; and
a plurality of carbon fibers disposed within the network.

10. The non-woven article of claim 9, wherein the article has an areal weight of less than 1400 g/m².

11. A method of forming a composite, comprising:
heating and compressing the article of claim 9 disposed on a carrier layer under conditions sufficient to melt the polycarbonate fibers and consolidate the network;
cooling the heated, compressed article and carrier layer under pressure to form the composite comprising a network comprising a plurality of polycarbonate fibers and a plurality of carbon fibers.

12. The method of claim 11, comprising heating and compressing a stack comprising from two to ten of the composites.

13. A thermoformable composite, comprising:
a network of melted, cooled polycarbonate fibers; and
a plurality of carbon fibers disposed within the network of polycarbonate fibers.

14. The composite of claim 13, wherein the composite has a minimum degree of loft of greater than or equal to about three.

15. A method of forming an article, comprising thermoforming a composite according to of claim 13 to form the article.

16. An article, comprising a thermoformed composite of claim 13.

17. The article of claim 13, further comprising a skin affixed thereto.

18. The article of claim 13, wherein the article is in the form of an aircraft interior panel.

19. The article of claim 13, the article having an areal weight of less than 1400 g/m².

20. The article of claim 13, wherein the article has an aspect ratio of from about 1:10,000 to about 1:1.
